(19) United States
(12) Patent Application Publication
(10) Pub. No.: US 2014/0175721 A1
(43) Pub. Date: Jun. 26, 2014

(54) MOTORISED DEVICE WITH A MOTOR MOUNTING

(71) Applicant: Eik Stieler, Hamburg (DE)

(72) Inventor: Eik Stieler, Hamburg (DE)

(73) Assignee: MAKITA CORPORATION, Anjo-shi, Aichi (JP)

(21) Appl. No.: 14/236,205

(22) PCT Filed: Jul. 19, 2012
(86) PCT No.: PCT/EP2012/064174

§ 371 Date: Jan. 30, 2014

(30) Foreign Application Priority Data
Aug. 3, 2011 (DE) 20 2011 050 893.5

(51) Int. Cl. B25F 5/02

(52) U.S. Cl. CPC B25F 5/02
USPC 267/141; 264/271.1

(57) ABSTRACT

In order to provide a motorised device, more particularly a hand-held tool such as a chainsaw, an angle grinder and/or a hand-held green space maintenance unit, with an combustion motor, which is envisaged for driving a tool of the motorised device and which is housed in a motor mounting with an improved motor mounting, which is simple to manufacture and allows flexible holding of different combustion motors in a motorised device, it is proposed that the motor mounting is designed as a plastic motor mounting and has a metal support frame which is overmoulded with the plastic material of the plastic motor mounting.

The present invention relates to a motorised device, more particularly a hand-held tool such as a chainsaw, an angle grinder and/or a green space maintenance unit, having a combustion motor which is envisaged for driving the motorised device and is housed in a motor mounting.

### PRIOR ART

DE 41 34 640 C1 discloses a motorised device designed as a chainsaw. The motorised device has a combustion motor which is intended for driving a tool, in that the combustion motor drives a chain sprocket, via which the tool can be driven. The combustion motor has a crank housing and the crank housing is screwed onto a fastening base, and the fastening base is designed as part of the housing. In this way a basic connection of the combustion motor with the housing of the motorised device is created.

The motor block of the combustion motor also has a fastening projection into which screw elements can be screwed. With the screw elements the combustion motor can be screwed to a tool holder, for example a chain-wheel or a rail on which the tool is directly or indirectly arranged.

Disadvantageously the one-part design of the fastening projection for holding the tools and the crank housing of the combustion motor results in a predefined arrangement of the combustion motor in its peripheral incorporation area. Through the one-part design of the crank housing with at least one, but preferably several holders and connection means, a flexible combination of different combustion motors with one or different implements is ruled out. Each combustion motor must have at least the same fastening projections, holders and connection structures, which in the case of different combustion motors which are also each to be advantageously combined with different motorised implements is not possible.

Although the motor can be housed in a simple plastic component and the plastic component can, for example, have fastening means corresponding to an adapted injection moulding tool which can be adapted to different combustion motors, this results in considerable tool costs and the exclusive use of plastic materials between the combustion motor and, for example, the motor holder, is not possible due to the strength limits of the plastic materials.

### DISCLOSURE OF THE INVENTION

It is therefore the aim of the present invention to create a motorised device with an improved motor mounting which is easy to manufacture and allows flexible housing of various combustion motors in a motorised device. More particularly, it is the aim of the present invention to create a motor mounting for a motorised device which is mechanically resilient and allows an combustion motor to be precisely positioned with regard to a tool holder.

This is achieved on the basis of a motorised device and a motor mounting in accordance with the introductory section of claim 1 in conjunction with the characterising features. Advantageous further developments of the invention are set out in the dependent claims.

The invention includes the technical teaching that the motor mounting is designed as a plastic motor mounting and has a metal support frame which is overmoulded with the plastic material of the plastic motor mounting.

Due to the metal support frame, which forms the shaping, force-absorbing basic structure of the motor mounting, the latter is highly resilient. The other advantages provided by a motor mounting made of a plastic material are also retained in the plastic motor mounting in accordance with the invention. For example, in spite of the highly resilient metal support frame the plastic material in the injection moulding can essentially be freely modelled. The motor mounting is there designed as a hybrid component and combines the advantages of a highly resilient metal material with the advantages of a plastic material. The interface between the motor mounting and the combustion motor can be formed by the motor mounting in accordance with the invention as a standard interface so that different combustion motors can be housed by the motor mounting.

In accordance with a special form of embodiment of the motorised device according to the invention, the plastic motor mounting has a tool holder onto which the tool, and onto which preferably one tool attachment element can be applied. Through forming a tool holder on the plastic motor mounting the combustion holder can be positioned precisely relative to the tool holder. Between the combustion motor and the applied tool and/or the applied tool attachment element there is only one further element which is formed by the plastic motor mounting itself. For example, the combustion motor drives a chain sprocket which is arranged on the crankshaft, with an intermediate centrifugal coupling. A saw chain runs over the chain sprocket and the saw chain is in turn guided by a saw chain bar. Consequently it is necessary that the chain sprocket and thus the combustion motor are precisely aligned with regard to the saw chain blade and the guide bar respectively. This precise alignment is made possible as both the plastic motor mounting in accordance with the invention as well as the tool attachment element on the motor mounting are each positioned in a highly precise manner.

A further special advantage is achieved if the tool holder is formed by the metal support frame, more particularly as a flange. The plastic motor mounting in accordance with the invention has a metal support frame which is essentially completely encased with the plastic material. The flange for forming the tool holder can form a section of the metal support frame which is free of plastic material. In this way the tool attachment element can be arranged directly on the metal support frame, allowing greater positioning accuracy and the transmission of greater forces. Overall, the arrangement of the tool attachment element can thus be particularly rigid vis-à-vis the combustion motor.

The plastic motor mounting can have a crank housing holder for a crank housing of the combustion motor. In the crank housing holder the combustion motor can be precisely positioned via its crank housing. The crank housing holder can be universally designed so the various combustion motors, which have different crank housings can be held in the crank housing holder.

In particular, the crank housing holder can have screw holes into which the screw elements for screwing on the crank housing can be inserted, wherein the screw holes are preferably formed in the metal support frame. For example the crank housing can have four screw holes, more particularly arranged in a rectangle, which correspond with four screw holes arranged in the same rectangle in the crank housing holder. Screw elements can thus be passed through the screw holds in order to firmly screw the crank housing to the crank housing holder.

If various combustions motors are to be held in the crank housing holder it may be sufficient if only the drilling pattern of the screw holes of the various combustion motors is the same. The combustion motors must also be designed so that the axis of rotation of the crankshaft relative to the holder interface of the crank housing holder is the same in the relative position in different combustion motors. As a result the particular advantage is achieved that different combustion motors, with otherwise the same peripherals of the motorised device, can be held and operated in the crank housing holder.

In accordance with a further advantageous example of embodiment of the motorised device, the plastic motor mounting can have at least one holder component for holding an ignition unit for operating the combustion motor. The holder component can also be formed by the metal support frame, more particularly in the form of a further flange, whereby the holder component in the form of a flange is free of the plastic material that otherwise surrounds the metal frame for forming the plastic motor mounting in accordance with the invention. The injection moulding tool with which the plastic motor mounting can be produced, can, for example, be designed in the area of the flange for forming the tool holder and/or in the area of the flange for forming the held piece, in such a way that no plastic mass flows around that area of the flange. Additionally or alternatively the metal support frame can be fully encased with plastic material and cutting work is subsequently carried out on the thus formed plastic motor mounting. During this the plastic material can be removed and at the same time the planar surfaces of the flange can be finished in such a way as to allow the precisely positioned attachment of, for example, the tool attachment element and/or the ignition unit for operating the combustion motor.

The flange for forming the tool holder and/or the flange for forming the holder component can have drilled holes in order to screw the tool attachment element and/or the ignition units to the relevant flange. In addition, the tool holder and/or the holder component can have cylinder borings into which the centring pins can be inserted to further improve the positioning precision, but also the mechanical resilience between the applied component and the plastic motor mounting.

The metal support can be made of an aluminium material and/or a magnesium alloy material. More particularly, the metal support frame can be designed so that it can be produced in a metal die-casting or other casting process. The plastic material for encasing the metal support frame can be made of a nylon material for example.

The objective of the present invention is also achieved through a plastic motor mounting for holding a combustion motor for a motorised device, more particularly a hand-held tool such as a chainsaw, an angle grinder and/or a hand-held green space maintenance unit, whereby in accordance with the invention the plastic motor mounting has a metal support frame which is overmoulded with the plastic material of the plastic motor mounting. The features and advantages of the plastic motor mounting set out above are also applicable to the plastic motor mounting in accordance with the invention.

The invention also relates to a method of manufacturing a plastic motor mounting for holding a combustion motor for a motorised device, more particularly for a hand-held tool such as a chain saw, an angle grinder and/or a green space maintenance unit, wherein the method comprises at least the stages of providing a metal support frame and of overmoulding the metal support frame with a plastic material.

### BRIEF DESCRIPTION OF THE DRAWINGS

Further measures for improving the invention are set out in more detail below together with a description of a preferred embodiment of the invention with reference to the figures. In these

FIG. 1 shows a view from above of the motor mounting of a motorised device in accordance with the invention,

FIG. 2 shows a first side view of the motorised device in accordance with FIG. 1 and

FIG. 3 shows a further side view of the motor mounting in accordance with FIG. 1.

### PREFERRED EXAMPLE OF EMBODIMENT OF THE INVENTION

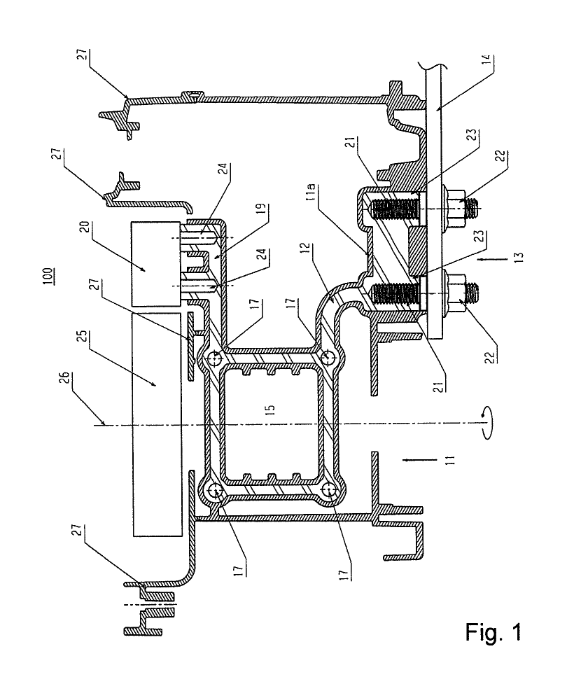

FIG. 1 show a view from above of a motor mounting 11 which holds a combustion motor of a motorised device 100. In accordance with the invention the motor mounting 11 is designed as a plastic motor mounting 11 and has a metal support frame 12 which forms the basic structure of the motor mounting 11. The metal support frame 12 is overmoulded with a plastic material 11a so that the plastic material 11a essentially completely encases the metal support frame 12. The plastic material 11a can be moulded around the metal support frame 12 by way of an injection moulding method. For this the metal support frame 12 can be inserted into a corresponding injection moulding mould and only then is the plastic mass injected into the hollow space between the injection moulding tool and the metal support frame 12. After the plastic mass has hardened the metal support frame 12 is overmoulded with plastic material 11a at the points geometrically predefined by the injection moulding tool.

The plastic motor mounting 11 has four screw holes 17 arranged in a rectangle which form a crank housing holder 15. In the crank housing holder 15 the combustion motor can be held, for example through its crank housing. In the crank housing there are also screw holes, which can be aligned with the screw holes 17. Screw elements can then be passed through the screw holes in the crank housing and the screw holes 17 in the plastic motor mounting 11 in order to screw the combustion motor to the plastic motor mounting 11.

The metal support frame 12, which can be made of an aluminium material and/or a magnesium alloy material, can withstand high mechanical stresses, so that the screw holes are preferably provided in the metal support frame 12. If the combustion motor is screwed to the metal support frame 12 the connection between the combustion motor and the plastic motor mounting 11 is mechanically highly resilient.

The plastic motor mounting 11 also has a tool holder 13. The tool holder 13 is for holding a tool attachment element 14, that is shown as rail for example, and on which a saw chain, for example, can be mounted or held therewith if the motorised device 100 is designed as a chain saw. The tool holder 13 forms a flange, in which, for example, there are two threaded holes 21. Screw elements 22 are screwed into the threaded holes in order to firmly screw the tool attachment element 14 to the tool holder 13. The view shows the tool holder 13 is such a way that it is formed by the metal support frame 12. The threaded holes 21 are surrounded by a hole bearing 23 which is formed by the metal support frame 12. In this way a resilient force flow between the tool attachment element 14 and the tool holder 13 can be assured without a pliant plastic material 11a being present between the metal support frame 12 and the tool attachment element 14.

The plastic motor mounting 11 also has a holder component 19 for holding an ignition unit 20 for operating the combustion motor. The ignition unit 20 is only shown as an example, whereby the plastic motor mounting 11 can for example have at least one further holder component 19 in order to hold further elements for operating the combustion motor. For example the ignition unit 20 can also be formed by a control unit for operating the motorised device or suchlike.

The holder component 19 is formed by a structural component of the metal support frame 12 and this is also designed in the form of a flange. The holder component 19 has threaded holes 24, into which the screw elements are screwed in order to hold the ignition unit 20 precisely in position on the holder component 19. The ignition unit 20 can interact with a cogwheel that is applied on the crankshaft of the combustion motor and rotates therewith in a motor axle 26. In doing so it is necessary for the ignition unit 20 to be particularly precisely positioned on the cogwheel 25 so that through the formation of the holder component 19 by the rigid metal support frame 12 in the form of a flange the ignition unit 20 can be advantageously arranged on the plastic motor mounting 11.

The plastic motor mounting 11 essentially forms a motor mounting on the coupling side of the combustion motor 10 and extends over this side and is initially designed in one piece. There is also a motor mounting 27 on the magnet side, i.e. on the side of the cogwheel 25, which is designed as a further single piece and which is located between the cogwheel 25 and the plastic motor mounting 11. The motor mounting 11 on the coupling side and the motor mounting 27 on the magnet side can then be bonded together by means of a plastic welding method.

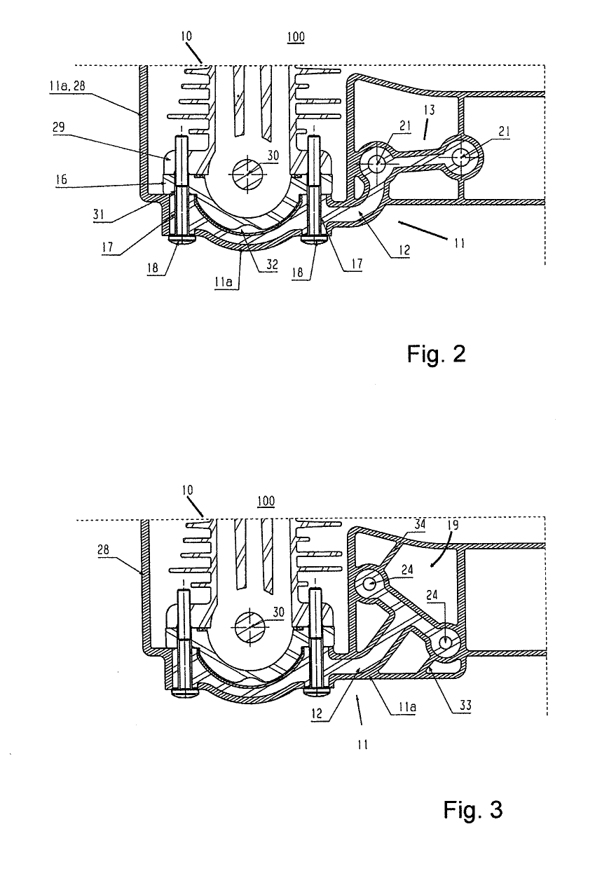

FIG. 2 shows a side view of the plastic motor mounting 11 of a motorised device 100, and in accordance with the invention the plastic motor mounting 11 is realised by an internally-located metal support frame 12 that is overmoulded with a plastic material 11a. It can be seen that the plastic material 11a forms further structural components of the motorised device 100. For example, the combustion motor 10 is surrounded by a housing 28 and the housing 28 is produced in one piece from the plastic material 11a plastic motor mounting 11.

The combustion motor 10 is shown by way of at least one crank housing 16 and adjoining the crank housing 16 is a cylinder, in which a piston performs stroke movements and drives a crankshaft 30.

The example of embodiment shows the combustion motor 10 screwed to the plastic motor mounting 11 by means of screw elements 18 which are initially passed through the screw holes 17 in the plastic motor mounting 11.

Through the screw holes 17 and a corresponding recess 32 in the plastic motor mounting 11 an advantageous crank housing holder 15 is created in which various combustion motors 10 can be arranged, without having to change the periphery and, in particular the plastic motor mounting 11.

To the side of the crank housing holder 15 the tool holder 13 is shown in the form of a flange and visible in the view are the threaded holes 21 into which the screw elements 22 can be screwed in order, for example, to connect the tool attachment element 14 (see FIG. 1) to the tool holder 13. It can be seen that the tool holder 13 is formed by the metal support frame 12 and the metal support frame 12 simultaneously forms the crank housing holder 15 in that the screw elements 18 are passed through the screw holes 17 in the metal support frame 12 and between the metal support frame 12 and the crank housing 16 there is no pliable plastic material 11a. This ensures a rigid and precise distance and a mechanically highly resilient connection between the tool holder 13 and the crank housing holder 15.

FIG. 3 shows a further side view of the plastic motor mounting 11 for holding a combustion motor 10 in the motorised device 100. The side view shows the holder component 19 for holding the ignition unit 20 (see FIG. 1), and in the holder component 19 there are threaded holes 24 for screwing the ignition unit 20 onto the holder component 19. The holder component 19 is designed as a structural component of the metal support frame 12 so that in turn a rigid connection between the crank housing holder 15 for holding the combustion motor 10 and the holder component 19 for holding the ignition unit 20 is created.

The side view of the example of embodiment shows further structural components of the motorised device 100 formed by the plastic material 11a of the plastic motor mounting 11. The structural components form, for example, reinforcement structures 33 and 34, which like the housing 28 are made in one piece from the plastic material 11a which at the same time surrounds the metal support frame 12 for form the plastic motor mounting 11.

In accordance with the invention a motor mounting 11 is created which through the metal support frame 12 is mechanically highly resilient and precise positioning of the combustion motor 10 with regard to further elements 14, 20 formed on the plastic motor mounting 11 is ensured. Particularly due to the rigid design of the metal support frame 12, for example on the basis of an aluminium material and/or a magnesium alloy material, the plastic motor mounting 11 is mechanically highly resilient, and due to the highly flexible manufacturing possibilities of plastic components the plastic material 11a provides the possibility of forming other structural components 28, 33 and/or 34 of the motorised device 100.

The invention is not restricted to the above-described preferred form example of embodiment. Rather, a number of variants are conceivable which make use of the described solution in fundamentally different types of embodiment. All the features and/or advantage set out in the claims, the description or the drawings, including design details, spatial arrangements and processing steps can be essential to the invention both in themselves or the most varied of combinations.

### LIST OF REFERENCES

100 Motorised device
10 Combustion motor
11 Motor mounting, plastic motor mounting
11a Plastic material
12 Metal support frame
13 Tool holder
14 Tool attachment element
15 Crank housing holder
16 Crank housing
17 Screw hole
18 Screw element
19 Holder component
20 Ignition unit
21 Threaded hole
22 Screw element
23 Hole bearing
24 Threaded hole
25 Cogwheel
26 Motor axle
27 Motor mounting MS
28 Housing
29 Cylinder
30 Crankshaft
31 Through-hole
32 Recess
33 Reinforcement structure
34 Reinforcement structure

1. A motorised device, more particularly a hand-held tool such as a chainsaw, an angle grinder and/or a hand-held green space maintenance unit, with an combustion motor, which is envisaged for driving a tool of the motorised device and which is housed in a motor mounting characterised in that the motor mounting is designed as a plastic motor mounting and has a metal support frame and is overmoulded with the plastic material of the plastic motor mounting.

2. The motorised device according to claim 1, characterised in that the plastic motor mounting has a tool holder to which the tool can be attached, preferably to a tool attachment element.

3. The motorised device according to claim 2, characterised in that the tool holder is formed by the metal support frame, more particularly in the form of a flange.

4. The motorised device according to claim 1, characterised in that the plastic motor mounting has a crank housing holder for holding a crank housing of the combustion motor and in which the crank housing can be held precisely in position.

5. The motorised device according to claim 3, characterised in that the crank housing holder has screw holes into which the screw elements for screwing on the crank housing can be fitted, wherein the screw holes are preferably formed in the metal support frame.

6. The motorised device according to claim 1, characterised in that the plastic motor mounting has at least one holder component for holding an ignition unit for operating the combustion motor.

7. The motorised device according to claim 6, characterised in that the holder component is formed by the metal support frame, more particularly in the form of flange.

8. The motorised device according to claim 1, characterised in that the metal support frame is made of an aluminium material and/or a magnesium alloy material.

9. The motorised device according to claim 1, characterised in that that the plastic material is in the form of a nylon.

10. A plastic motor mounting for housing an combustion motor for a motorised device, more particularly for a hand-held tool such as a chainsaw, an angle grinder and/or a green space maintenance unit, characterised in that the plastic motor mounting has a metal support frame which is overmoulded with the plastic material of the plastic motor mounting.

11. The plastic motor mounting for housing an combustion motor for a motorised device, more particularly for a hand-held tool such as a chainsaw, an angle grinder and/or a green space maintenance unit, characterised in that the plastic motor mounting has a metal support frame which is overmoulded with the plastic material of the plastic motor mounting with the features according to claim 2.

12. A method of manufacturing a plastic motor mounting for housing a combustion motor for a motorised device, more particularly for a hand-held tool such as a chainsaw, an angle grinder and/or a green space maintenance unit, wherein the method comprises at least the following steps:
Provision of a metal support frame,
Overmoulding of the metal support frame with a plastic material.
